(19) United States
(12) Patent Application Publication
(10) Pub. No.: US 2008/0266214 A1
(43) Pub. Date: Oct. 30, 2008

(54) SUB-PIXEL CURRENT MEASUREMENT FOR OLED DISPLAY

(75) Inventors: Walter Edward Naugler, Katy, TX (US); Sung Gu Kang, San Jose, CA (US); Cheon Hong Kim, Sunnyvale, CA (US)

Correspondence Address: FENWICK & WEST LLP, SILICON VALLEY CENTER, 801 CALIFORNIA STREET, MOUNTAIN VIEW, CA, 94041, US

(73) Assignee: LEADIS TECHNOLOGY, INC., Sunnyvale, CA (US)

(21) Appl. No.: 12/018,455

(22) Filed: Jan. 23, 2008

Related U.S. Application Data
(60) Provisional application No. 60/925,990, filed on Apr. 24, 2007.

(51) Int. Cl. G09G 3/30

(52) U.S. Cl. 345/76

(57) ABSTRACT

An active matrix drive system drives an emissive display device such as an organic light-emitting diode display and is configured to measure sub-pixel current in the emissive display device. One or more power column power lines of the emissive display device are turned off while sub-pixel current is measured. As a result, the sub-pixel current is relative large compared to the background current of the emissive display device, which facilitates accurate measurement of the sub-pixel current.

### CROSS-REFERENCE TO RELATED APPLICATION

This application claims priority under 35 U.S.C. § 119(e) from co-pending U.S. Provisional Patent Application No. 60/925,990 entitled “Sub-pixel Current Measurement” filed on Apr. 24, 2007, which is incorporated by reference herein in its entirety.

### BACKGROUND OF THE INVENTION

1. Field of the Invention

The present invention relates to measuring the sub-pixel current of an emissive display such as an OLED (Organic Light-Emitting Diode) display.

2. Description of the Related Arts

An OLED display is generally comprised of an array of organic light emitting diodes (OLEDs) that have carbon-based films disposed between two charged electrodes. Generally one electrode is comprised of a transparent conductor, for example, indium tin oxide (ITO). Generally, the organic material films are comprised of a hole-injection layer, a hole-transport layer, an emissive layer and an electron-transport layer. When voltage is applied to the OLED, the injected positive and negative charges recombine in the emissive layer and transduce electrical energy to light energy. Unlike liquid crystal displays (LCDs) that require backlighting, OLED displays are self-emissive devices—they emit light rather than modulate transmitted or reflected light. Accordingly, OLEDs are brighter, thinner, faster and lighter than LCDs, and use less power, offer higher contrast and are cheaper to manufacture.

An OLED display typically includes a plurality of OLEDs arranged in a matrix form including a plurality of rows and a plurality of columns, with the intersection of each row and each column forming a pixel of the OLED display. An OLED display is generally activated by way of a current driving method that relies on either a passive-matrix (PM) or an active-matrix (AM) scheme.

In a passive matrix OLED display, a matrix of electrically-conducting rows and columns forms a two-dimensional array of picture elements called pixels. Sandwiched between the orthogonal column and row lines are thin films of organic material of the OLEDs that are activated to emit light when current is applied to the designated row and column lines. The brightness of each pixel is proportional to the amount of current applied to the OLED of the pixel. While PM OLEDs are fairly simple structures to design and fabricate, they demand relatively expensive, current-sourced drive electronics to operate effectively and are limited to the number of lines because only one line can be on at a time and therefore the PM OLED must have overall brightness equal to the desired average brightness times the number of lines. Thus, PM OLED displays are typically limited to under 100 lines. In addition, their power consumption is significantly higher than that required by an active-matrix OLED. PM OLED displays are most practical in alpha-numeric displays rather than higher resolution graphic displays.

An active-matrix OLED (AM OLED) display is comprised of OLED pixels that have been deposited or integrated onto a thin film transistor (TFT) array to form a matrix of pixels that emit light upon electrical activation. In contrast to a PM OLED display, where electricity is distributed row by row, the active-matrix TFT backplane acts as an array of switches coupled with sample and hold circuitry that control and hold the amount of current flowing through each individual OLED pixel during the total frame time. The active matrix TFT array continuously controls the current that flows to the OLEDs in the each of pixels, signaling to each OLED how brightly to illuminate.

FIG. 1 illustrates a conventional active matrix OLED display. While the example of FIG. 1 is illustrated as an OLED display, other emissive-type displays would have structures similar to that illustrated in FIG. 1. Referring to FIG. 1, the OLED display panel includes a plurality of rows R1, R2, . . . , Rn and a plurality of columns C1, C2, . . . Cm arranged in a matrix. The intersection of each row and each column forms a pixel of the OLED display. For a color OLED display, each pixel includes 3 sub-pixels that have identical structure but emit different colors (R, G, B). For simplicity of illustration, FIG. 1 illustrates only one sub-pixel (denoted as dashed line boxes in FIG. 1, such as box 100) corresponding to one of the R, G, B colors per pixel at the intersection of each row and each column. However, in real OLED display panels, each pixel includes three identical ones of the sub-pixel structure as illustrated in FIG. 1.

As shown in FIG. 1, the active drive circuitry of each sub-pixel 100 includes TFTs T1 and T2 and a storage capacitor Cs for driving the OLED D1 of the sub-pixel 100. In the following explanation of FIG. 1, the type of the TFTs T1 and T2 is an n-channel TFT. However, note that p-channel TFTs may also be utilized in the active matrix. The data line (Data) is connected to the drain of TFT T1. The gate of TFT T1 is connected to gate line 150, which would carry an over-voltage of 25 to 30 volts (when active) to enable the TFT T1 to operate as a switch. The source of TFT T1 is connected to the gate of TFT T2 and to one side of storage capacitor Cs. The drain of TFT T2 is connected to positive supply voltage VDD. The other side of storage capacitor Cs is also connected, for example, to the positive supply voltage VDD. Note that the storage capacitor Cs may be tied to any reference electrode in the pixel. The source of TFT T2 is connected to the anode of OLED D1. The cathode of OLED D1 is connected to negative supply voltage Vss or common Ground.

The continuous current flow to the OLEDs is controlled by the two TFTs T1, T2 of each sub-pixel. TFT T1 is used to start and stop the charging of storage capacitor Cs, and TFT T2 provides a voltage source at the level needed to create a constant current to the OLED D1. As a result, the AM OLED operates at all times (i.e., for the entire frame scan), avoiding the need for very high currents required for passive matrix operation. The TFT T1 samples the data on the data line (Data), which is held as charge stored in the storage capacitor Cs. The voltage held on the storage capacitor Cs is applied to the gate of the second TFT T2. In response, TFT T2 drives current through the OLED D1 to a specific brightness depending on the value of the sampled and held data signal as stored in the storage capacitor Cs.

The OLED display requires regulated current in each sub-pixel to produce a desired brightness from the pixel. Ideally, the TFTs T2 in each sub-pixel 100 should be good current sources that deliver the same current for the same gate voltage over the lifetime of the OLED display. Also each current source TFT T2 in the active TFT matrix must deliver the same current for the same data voltage stored in the storage capacitor Cs in order that the display is uniform. However, uniform TFTs are very difficult to produce and thus the current supplied by TFTs T2 in conventional OLED displays is often non-uniform, resulting in non-uniform display brightness. In order to correct such non-uniformities in the drive current through the OLEDs in the OLED display, it is necessary to measure the actual current through each OLED of the sub-pixels in the OLED display.

However, accurately measuring the actual current through each OLED of the subpixels of the OLED panel is not simple, due to the large number of pixels in an OLED display panel. A conventional way of measuring the current in one sub-pixel is to measure the current flowing in either the VDD line or the VSS line of the sub-pixel. The current in the VDD or VSS line is first measured with all pixels turned off to establish a background (leakage) current (also called the dark current). Then one sub-pixel is turned on, which would result in an increase in the current in the VDD and VSS line by the turned-on sub-pixel (OLED). Typically the current increase resulting from the turned-on sub-pixel is between a few nanoamperes and one microampere.

The background current, however, is comprised of the leakage current through all the TFTs T2 and Cs capacitors in the OLED display, because all the sub-pixels are tied to the supply voltages VDD and VSS through the column power lines in a conventional OLED display. For example, a VGA resolution (NTSC-monochromatic) display has 640×480 pixels (m=640, n=480). In the case of a full color display, each pixel is made up of three sub-pixels, red (R), green (G), and blue (B). Therefore, the total number of columns in a VGA full color display is 640×3=1920 columns (m=1920). Thus, the total number of sub-pixels in a full color VGA display is 1920×480=921,600 sub-pixels, or almost a million sub-pixels. Typically, the leakage in a single TFT T2 can be 10 picoamperes. Therefore, the total background (leakage) current of a VGA full color OLED display can be approximately 10 microamperes (1 million sub-pixels×10 pA). Since the background current (10 microamperes) is very large compared to the current increase resulting from a single turned-on sub-pixel (between a few nanoamperes and one microampere), it is extremely difficult to measure the sub-pixel current accurately.

### SUMMARY OF THE INVENTION

Embodiments of the present invention include an active matrix drive system for driving an emissive display device and configured to measure sub-pixel current in the emissive display device, where one or more power column power lines of the emissive display device are disconnected from the supply voltage while sub-pixel current is measured. As a result, the sub-pixel current is relatively large compared to the background current of the emissive display device, which facilitates accurate measurement of the sub-pixel current.

In one embodiment, the active matrix drive system comprises an active matrix drive circuit configured to drive current through a plurality of emissive display elements arranged in a matrix of a plurality of rows and a plurality of columns where each of the emissive display elements corresponds to a subpixel of the emissive display device and is configured to have its current flow through a corresponding one of a plurality of column power lines, a plurality of first switches each coupled to a corresponding one or more of the column power lines where the corresponding one or more of the column power lines receives supply voltage and the current flows through the corresponding one or more of the column power lines if the corresponding first switch is turned on, but the corresponding one or more of the column power lines does not receive supply voltage and the current does not flow through the corresponding one or more of the column power lines if the corresponding first switch is turned off, and a current measurement device coupled to a common cathode of the emissive display elements where the current measurement device is configured to measure combined current from emissive display elements.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates a conventional active matrix OLED display.

FIG. 2A illustrates an active matrix OLED display configured for normal operation, according to one embodiment of the present invention.

FIG. 2B illustrates the active matrix OLED display configured for sub-pixel current measurement, according to one embodiment of the present invention.

FIG. 3 illustrates the active matrix OLED display configured for sub-pixel current measurement, according to another embodiment of the present invention.

FIG. 4 illustrates a method of measuring sub-pixel current in the active matrix OLED display, according to one embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

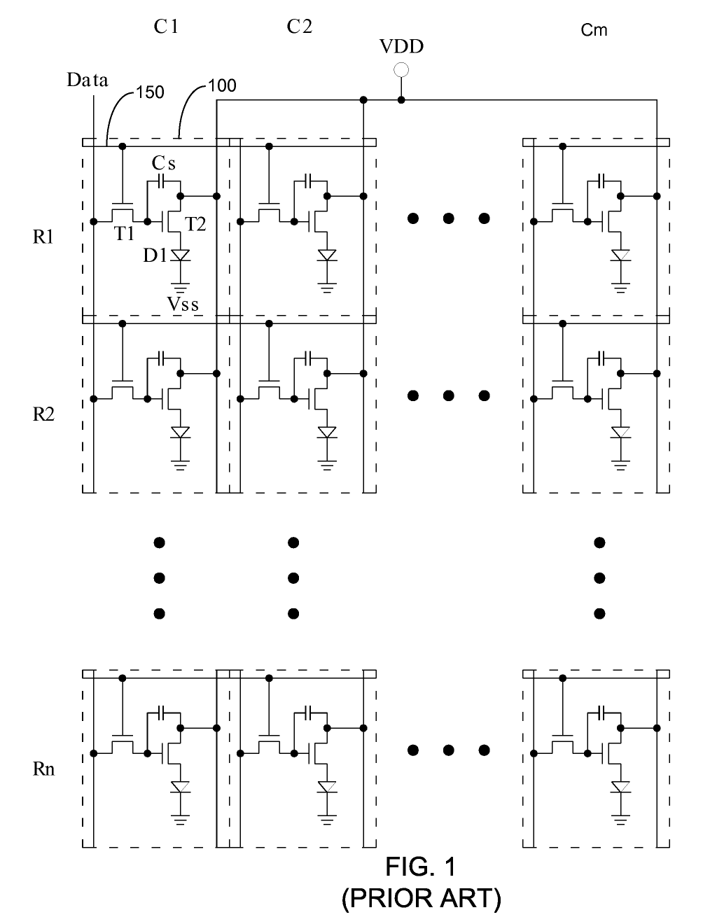

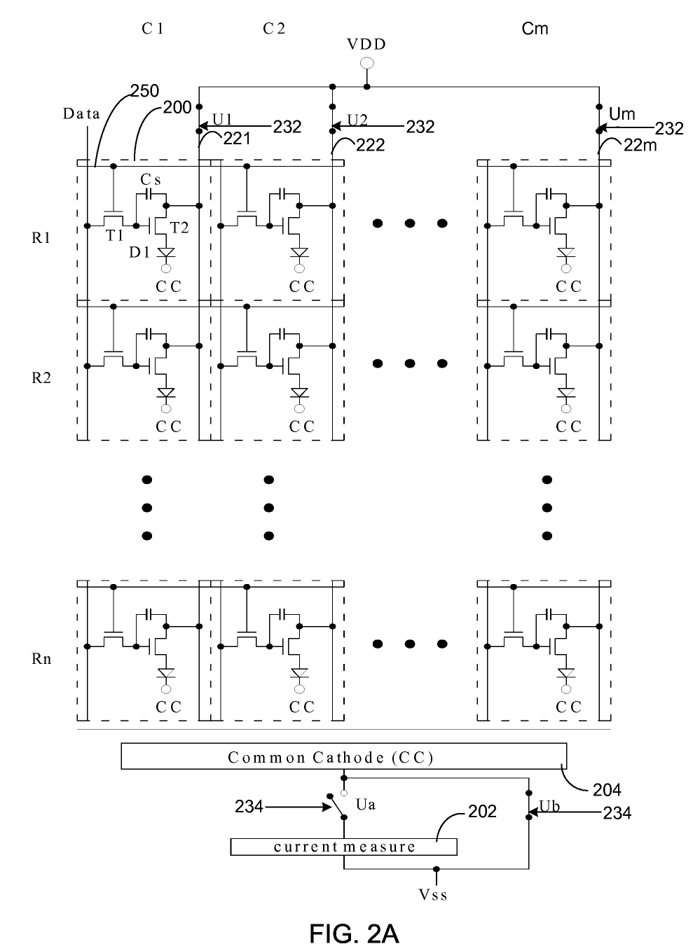

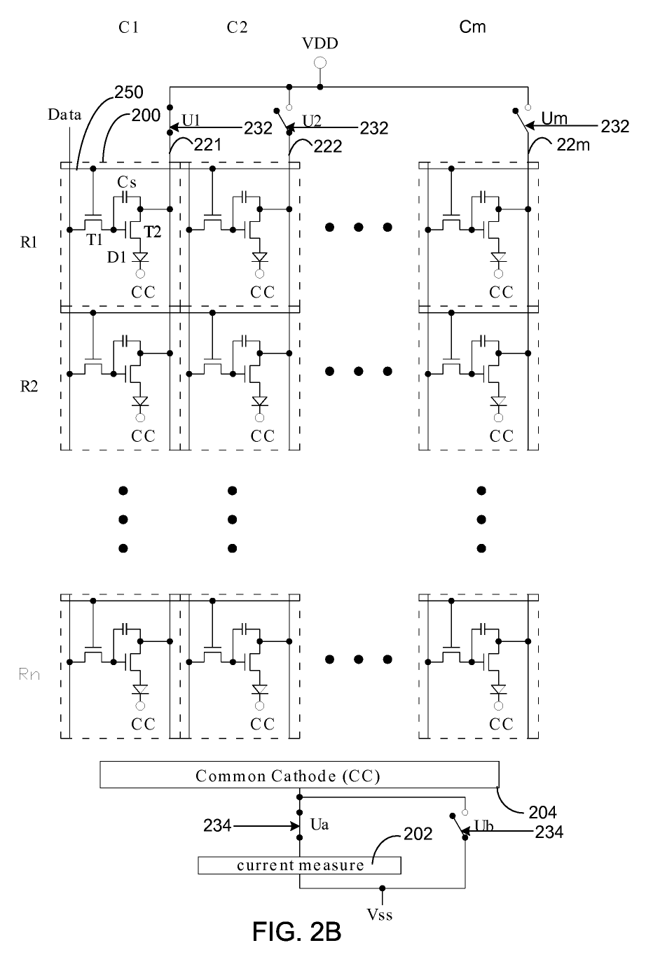

FIG. 2A illustrates an active matrix OLED display, according to one embodiment of the present invention. While the embodiment of FIG. 1 is illustrated as an OLED display, other emissive-type displays such as PDPs (plasma display panels) may also be used with the present invention.

Referring to FIG. 2A, the OLED display includes a plurality of rows R1, R2, . . . , Rn and a plurality of columns C1, C2, . . . Cm arranged in a matrix form. The intersection of each row and each column forms a pixel of the OLED display. The embodiment of FIG. 2A is for a color OLED display, and thus each pixel includes 3 sub-pixels that have identical structures but emit different colors (R, G, B). For simplicity and clarity of illustration, FIG. 2A illustrates only one sub-pixel (denoted as dashed line boxes in FIG. 2A, such as box 200) corresponding to one of R, G, B colors per pixel at the intersection of each row and each column. However, in real OLED display panels, each pixel includes three identical ones of the sub-pixel structure as illustrated in FIG. 2A. Each sub-pixel includes an OLED D1 that illuminates in response to current flowing through the OLEDs D1. All the cathodes of the OLEDs D1 in each sub-pixel connected to a common cathode (CC) 204 that combines the current flowing through the OLEDs D1 (through the column supply lines 221, 222, . . . , 22m).

The common cathode 204 is connected to two switches Ua, Ub. Switch Ua connects the common cathode 204 to the current measurement circuit 202. Switch Ub is connected between the common cathode 204 and the negative supply voltage Vss. FIG. 2A illustrates the situation in which switch Ua is open (off) and switch Ub is closed (on), thereby allowing the combined current in the common cathode 204 to bypass the current measurement circuit 202 and flow directly to the negative power supply Vss. The current measurement circuit 202 may be any state of the art current measurement device that can accurately measure current flowing through it. One example of a current measuring circuit 202 is the charging of a capacitor (not shown herein) for a specific time interval. The voltage is then measured across the capacitor, which indicates how much charge has accumulated in the capacitor during the specific time interval. The current is then determined by dividing the accumulated charge by the time interval.

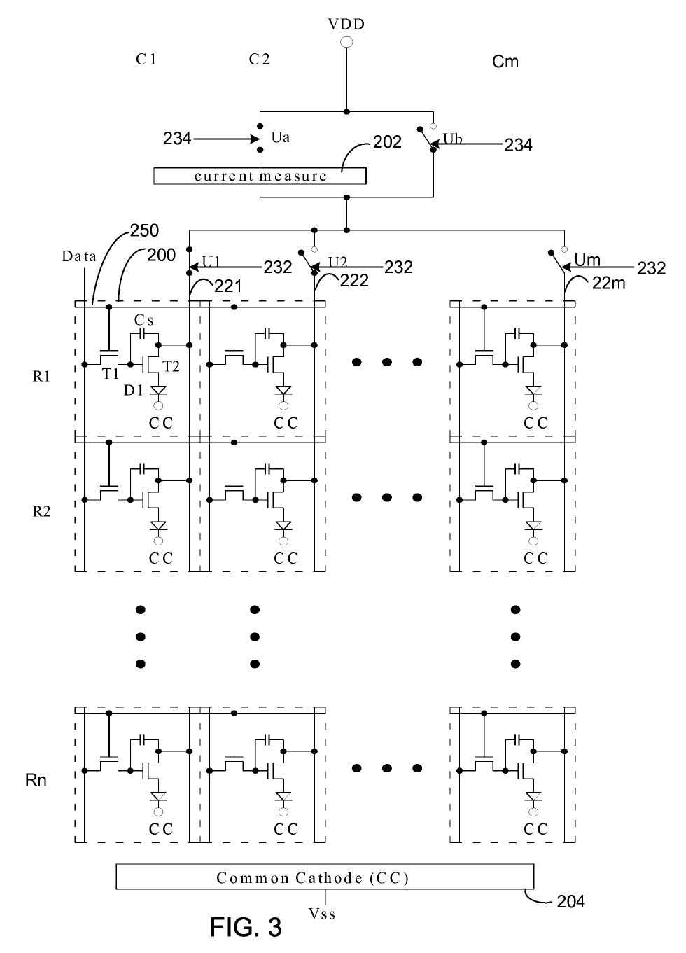

As shown in FIG. 2A, the active drive circuitry of each sub-pixel 200 includes TFTs T1 and T2 and a storage capacitor Cs for driving the OLED D1 of the sub-pixel 200. In the following explanation of FIGS. 2A, 2B, and 3, the type of the TFTs T1 and T2 is an n-channel TFT. However, note that p-channel TFTs may also be utilized in the active matrix as the TFTs T1, T2. The data line (Data) is connected to the drain of TFT T1. The gate of TFT T1 is connected to gate line 250, which would carry an over-voltage of 25 to 30 volts (when active) to enable the TFT T1 to operate as a switch. The source of TFT T1 is connected to the gate of TFT T2 and to one side of storage capacitor Cs. The drain of TFT T2 in each sub-pixel is connected to the corresponding one of the column power lines 221, 222, . . . , 22m. Each of the column power lines 221, 222, 22m is connected to the corresponding one of switches (U1, U2, . . . , or Un) that connect/disconnect the column power lines 221, 222, 22m to/from the positive supply voltage VDD depending upon whether the switch (U1, U2, . . . , or Un) is on or off. The other side of storage capacitor Cs is also connected to column power lines 221, 222, 22m. The source of TFT T2 is connected to the anode of OLED D1. The cathode of OLED D1 is connected to the common cathode (CC), which is shown separately toward the bottom part of FIG. 2A with reference numeral 204. The structure of each sub-pixel 200 is repeated in all the sub-pixels of the OLED display.

The continuous current flow to the OLEDs D1 is controlled by the two TFTs T1, T2 of each sub-pixel. TFT T1 is used to start and hold the charging of storage capacitor Cs, and TFT T2 provides a voltage source at the level needed to create a constant current to the OLED D1. More specifically, the TFT T1 samples the data on the data line (Data), which is held as charge stored in storage capacitor Cs. The voltage held on storage capacitor Cs is applied to the gate of the TFT T2. In response, TFT T2 drives current through the OLED D1 to a specific brightness depending on the value of the current, which is controlled by the sampled and held data signal as stored in storage capacitor Cs.

As explained above, a switch (U1, U2, . . . , or Um) is inserted at the head of each column connecting or disconnecting the column power line (221, 222, . . . , or 22m) to or from the supply voltage VDD. Control signal 232 controls the turning on and off of the switches (U1, U2, . . . , or Um). For example, the control signal 232 may be an m-bit signal with each bit corresponding to one of the column power lines (221, 222, . . . , 22m) and controlling the turning on and off of the corresponding one of the switches (U1, U2, . . . , or Um). When a switch (U1, U2, . . . , or Um) is turned on, the corresponding column power line (221, 222, . . . , or 22m) is connected to the supply voltage VDD. When a switch (U1, U2, . . . , or Um) is turned off, the corresponding column power line (221, 222, . . . , or 22m) becomes disconnected from the supply voltage VDD. FIG. 2A illustrates that all the column power lines (221, 222, . . . , and 22m) are connected to the supply voltage VDD through the switches (U1, U2, . . . , and Um) during normal operation of the OLED display.

A current measurement device 202 is connected between the common cathode CC 204 and the negative supply voltage Vss through switch Ua. In addition, switch Ub is connected between the common cathode 204 and the negative supply voltage Vss directly, bypassing the current measurement device 202. Control signal 234 controls the turning on and off of switches Ua and Ub. Switches Ua and Ub are turned on and off in an alternating manner by the control signal 234. Specifically, when switch Ua is turned on, switch Ub is turned off and the common cathode 204 becomes connected to the current measurement device 202. As a result, the combined current from OLEDs D1 of all the sub-pixels can be measured by the current measurement device 202. On the other hand, when switch Ua is turned off, switch Ub is turned on, and the common cathode (CC) 204 is connected to the negative power supply Vss directly, bypassing the current measurement device 202. As a result, the OLED display operates in normal operation mode with no current measurement function involved. FIG. 2A illustrates the circuit configuration in such normal operation mode where all switches U1, U2, . . . , and Um are turned on (closed) by control signal 232, and switch Ua is turned off and switch Ub is turned on by control signal 234.

Switches U1, U2, . . . , Um, Ua, and Ub may be formed as poly-silicon MOSFETs (Metal Oxide Semiconductor Field Effect Transistors), alpha-silicon MOSFETs, TFTs, single crystalline silicon MOSFETs, or any other semiconductor MOSFETs. Because the switches U1, U2, . . . , Um, Ua, and Ub handle a large amount of current combined from all the sub-pixels connected to one column or multiple columns, the size of the switches U1, U2, . . . , Um, Ua, and Ub is much larger than the size of the TFTs T1, T2 in each sub-pixel. In one embodiment, switches U1, U2, . . . , Um, Ua, and Ub may be formed together with the other TFTs T1, T2 of the active matrix in an integrated circuit. In another embodiment, switches U1, U2, . . . , Um, Ua, and Ub may be formed as discrete components separate from the TFTs T1, T2 of the active matrix for the OLED display.

FIG. 2B illustrates the active matrix OLED configured for sub-pixel current measurement, according to one embodiment of the present invention. The active matrix circuitry of FIG. 2B is identical to that illustrated in FIG. 2A. However, in the example of FIG. 2B, control signal 232 turns on switch U1 to connect column power line 221 to the supply voltage VDD, while turning off other switches U2 through Um thereby disconnecting the remaining column power lines 222 through 22m from the supply voltage VDD. In addition, control signal 234 turns on switch Ua and turns off switch Ub, thereby connecting the common cathode (CC) 204 to the current measurement device 202.

As a result, current through the OLEDs D1 in one or more of the sub-pixels 200 of column C1 may be measured by the current measurement device 202. For example, if row R1 is turned on as well, current through the OLED D1 in the sub-pixel 200 corresponding to row R1, column C1 can be measured by the current measurement device 202. If more than one row is turned on, then the combined current through the OLEDs D1 in one or more of the turned-on sub-pixels of column C1 may be measured by the current measurement device 202. Theoretically, according to the embodiment shown in FIG. 2B, the background current is reduced to 1/1920 of what the background current would be with a conventional VGA OLED display such as that shown in FIG. 1, because only one of the 1920 columns (column C1 in the example of FIG. 2B (column power line 221)) of an OLED VGA display is connected to the supply voltage VDD and the remaining columns (columns C2 through Cm (column power lines 222 through 22m)) are disconnected from their supply voltage VDD.

However, some small leakage current in the open switches U2 through Um may be expected. For example, switches U1 through Um could be polysilicon thin film transistors deposited at the same time as the rest of the active matrix is deposited. Polysilicon TFTs are leaky and each polysilicon TFT could leak as much as 10 picoamperes. Therefore, the background current could be as much as 1920×10 picoamperes=19.2 nanoamperes. Such background current is a substantial improvement to the background current in a conventional VGA OLED display such as that shown in FIG. 1, which could be approximately 10 microamperes as explained above with reference to FIG. 1. The background current may be further reduced to less than 1 picoampere by using double gated TFTs for the switches U1 through Um. An alternative to using TFTs as the switches U1 through Um is to use single crystal silicon integrated circuit switches as the switches U1 through Um. While the embodiment of FIGS. 2A and 2B includes one switch (U1 through Um) per column, any number of switches may be used for any number of columns to reduce the background current to some degree as needed. For example, 3 columns or 10 column power lines may be grouped together and share one switch U for connection to the supply voltage VDD. Using a fewer number of switches would reduce the size of the active matrix control circuit of the OLED display, while resulting in less reduction of the background current of the OLED display.

FIG. 3 illustrates the active matrix OLED display configured for sub-pixel current measurement, according to another embodiment of the present invention. The circuitry in each sub-pixel 200 of the embodiment of FIG. 3 is identical to the circuitry of each sub-pixel 200 in the embodiment of FIGS. 2A and 2B. However, the current measurement device 202 and switches Ua, Ub are placed in a different part of the active matrix circuitry.

Specifically, the current measurement device 202 in the embodiment of FIG. 3 is moved to the side of the supply voltage VDD. More specifically, the current measurement device 202 on one side is connected to the switches U1, U2, , . . . , Um corresponding to the column power lines 221, 222, . . . , 22m, rather than to the common cathode 204. The current measurement device 202 on the other side is connected to switch Ua. Switch Ua is connected between the current measurement device 202 and supply voltage VDD, and switch Ub is connected between supply voltage VDD and the column power lines 221, 222, . . . , 22m directly. Control signal 232 may turn on one or more of switches U1, U2 . . . , Um to connect one or more of the corresponding column power line 221, 222, . . . , or 22m to the supply voltage VDD (in normal operation mode through switch Ub) or indirectly to the supply voltage VDD through the current measurement device 202 (in sub-pixel current measurement mode through switch Ua). Control signal 232 may turn off remaining ones of the switches U1 through Um thereby disconnecting the remaining column power lines 221 through 22m from the supply voltage VDD or the current measurement device 202.

Similar to the embodiment shown in FIGS. 2A and 2B, switches Ua and Ub are used to connect or disconnect the current measurement device 202 to or from the column power lines 221, 222, . . . , 22m, depending on whether the OLED display is in normal operation mode or the sub-pixel current measurement mode. More specifically, when the OLED display is in normal operation mode, control signal 234 turns off (opens) switch Ua and turns on (closes) switch Ub. Thus, current measurement device 202 is bypassed and the supply voltage VDD is coupled directly to the column power lines 221, 222, . . . , 22m (if the corresponding switches U1, U2, . . . , Um are turned on). When the OLED display is in sub-pixel current measurement mode, control signal 234 turns on (closes) switch Ua and turns off (opens) switch Ub. Thus, the supply voltage VDD is coupled to the column power lines 221, 222, . . . , 22m through the current measurement device 202 (if the corresponding switches U1, U2, . . . , Um are turned on). Thus, the combined current through all the column power lines (i.e., through all the columns of the OLED display) that are turned on by the control signal 232 flows through the current measurement device 202 and thus can be measured.

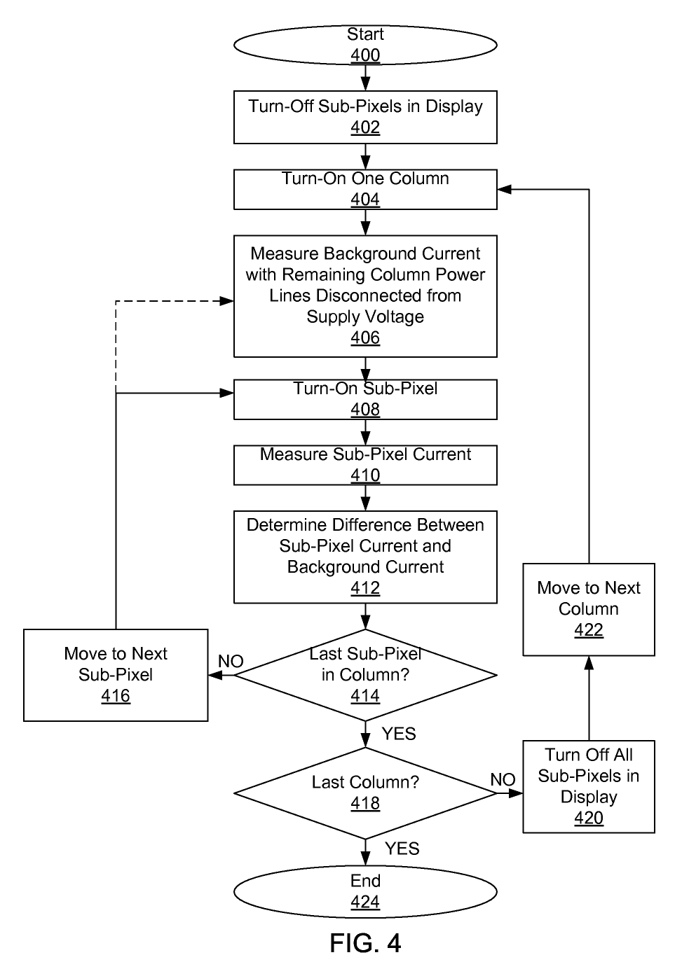

FIG. 4 illustrates a method of measuring sub-pixel current in the active matrix OLED display, according to one embodiment of the present invention. The method of FIG. 4 is explained with reference to FIG. 2B and FIG. 3, and can be used with either one of the embodiments of FIG. 2B and FIG. 3.

As the process is started 400, all sub-pixels of the OLED display are turned off 402. Then, one column is turned on 404, for example, column C1 is turned on by turning on switch U1 and turning off other switches U2 through Um with the control signal 232. In this manner, only column power line 221 is connected to the supply voltage VDD and the remaining column power lines 222 through 22m are disconnected from the supply voltage VDD. Then, the background current I₁ is measured 406 using the current measurement device 202, with the remaining column power lines 222 through 22m disconnected from the supply voltage VDD. As explained above, switch Ua is turned on and switch Ub is turned off to active the current measurement device 202 in order to measure the background current of the OLED display. As explained above, the background current is very small compared to that of conventional OLED displays, because the other columns C2 through Cm (column power lines 222 through 22m0 are turned off.

Next, one of the sub-pixels is turned on 408. For example, the sub-pixel at row R1, column C1 is turned on by turning on switch U1 and asserting appropriate data to the Data lines connected to TFTs T1, T2. Specifically, in order to turn on a sub-pixel (for example, subpixel at R1, C1), the corresponding column power line 221 is turned on by closing the corresponding switch U1, data is loaded on the data line (Data), and the row line (also referred to as gate line 250) which is connected to all the gates of TFTs T1s in a row is turned on. In normal operation, the data for a row is loaded to a line buffer (not shown), and when the row line 250 is activated all the TFTs T1 in the row are turned on to allow the data voltage in the line buffer transfer to all the storage capacitors Cs in the row through the data line (Data). Using the current measurement device 202, the current I₂ through that turned-on sub-pixel is measured 410. Again, switch Ua is turned on and switch Ub is turned off to activate the current measurement device 202 in order to measure the sub-pixel current. The remaining column power lines 222 through 22m are disconnected from the positive supply voltage VDD by the turned-off switches U2 through Um while the sub-pixel current is measured. Then, the difference (I₂−I₁) between the measured sub-pixel current I₂ and the background current I₁ is determined 412. Such difference (I=I₂−I₁) is the measure of the actual sub-pixel current without the background current and can be stored in a storage device (not shown).

Then, it is determined 414 whether the measured sub-pixel is the last sub-pixel in the turned-on column. If the measured sub-pixel is not the last sub-pixel in the turned-on column, the process moves 416 to the next sub-pixel (for example, R2/C1, R3/C1, and so on) to repeat steps 408, 410, 412, 414. Alternatively, the process may go back from step 416 to step 406 to re-measure 406 the background current and repeat steps 406, 408, 410, 412, 414 for the next sub-pixel. If the measured sub-pixel is the last sub-pixel in the turned-on column, then it is determined 418 whether the turned-on column is the last column in the OLED display. If the turned-on column is not the last column in step 418, then all the sub-pixels in the OLED display are again turned off 420 and the process moves 422 to the next column (for example, C2, C3, . . . , and so on) to repeat steps 404, 406, 408, 410, 412, 414, 416, 418. If the turned-on column is the last column in step 418, then the current in all sub-pixels have been measured and the process ends 424. Note that the order in which the sub-pixels are measured as illustrated herein is merely exemplary and that the sub-pixel current may be measured in other sequences.

In one embodiment, the present invention may be used to measure sub-pixel current from the TFTs T2 while they are biased to operate in saturation mode. Such sub-pixel current measurements with TFTs T2 in saturation can be used to compensate for the difference in sub-pixel current from sub-pixel to sub-pixel through compensation techniques (not explained herein) and to force uniformity of the sub-pixel current for the active matrix in OLED displays where the active matrix itself is not able to provide uniform sub-pixel current in a stand-alone manufacturing process.

In another embodiment, the present invention can be used to measure the sub-pixel current when the TFTs T2 are biased to operate in their linear region. Such sub-pixel current measurements with TFTs T2 operating in their linear region can be used to correct non-uniform pixel brightness that occurs as the pixels of the OLED display age. Therefore, stuck images (ghosting, burned in images, etc.) and color drift due to uneven aging of the three colors (RGB) in the OLED display may be corrected.

Upon reading this disclosure, those of skill in the art will appreciate still additional alternative structural and functional designs for measuring sub-pixel current in emissive displays such as OLED displays. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A drive system for driving an emissive display device, the drive system configured to measure sub-pixel current in the emissive display device, the drive system comprising:
an active matrix drive circuit configured to drive current through a plurality of emissive display elements arranged in a matrix of a plurality of rows and a plurality of columns, each of the emissive display elements corresponding to a subpixel of the emissive display device and configured to have its current flow through a corresponding one of a plurality of column power lines;
a plurality of first switches each coupled to a corresponding one or more of the column power lines, the corresponding one or more of the column power lines receiving supply voltage if the corresponding first switch is turned on, but the corresponding one or more of the column power lines not receiving the supply voltage if the corresponding first switch is turned off; and
a current measurement device coupled to a common cathode of the emissive display elements, the current measurement device configured to measure combined current from the emissive display elements.

2. The drive system of claim 1, wherein at least some of the first switches is turned off to disconnect the corresponding one or more of the column power lines from the supply voltage while the current measurement device measures the combined current from the emissive display elements.

3. The drive system of claim 1, further comprising:
a second switch coupled between the current measurement device and the common cathode of the emissive elements, the second switch being turned on to couple the current measurement device to the common cathode or turned off to disconnect the current measurement device from the common cathode; and
a third switch coupled between the common cathode of the emissive elements and another supply voltage, the third switch being turned on while the second switch is turned off, and the third switch being turned off while the second switch is turned on.

4. The drive system of claim 1, wherein the active matrix drive circuit includes, for each sub-pixel, a first n-channel thin film transistor, a second n-channel thin-film transistor, and a storage capacitor, and wherein:
a drain of the first thin-film transistor is coupled to a data line, a gate of the first thin-film transistor is coupled to a row line, and a source of the first thin-film transistor is coupled to a first side of the storage capacitor;
a second side of the storage capacitor is coupled to a drain of the second thin-film transistor and to a corresponding one of the column power lines;
a gate of the second thin-film transistor is coupled to the source of the first thin-film transistor and to the first side of the storage capacitor, a drain of the second thin-film transistor is coupled to the second side of the storage capacitor and to the corresponding one of the column power lines, and a source of the second thin-film transistor is coupled to an anode of the emissive display element of the sub-pixel;
the storage capacitor is charged according to data on the data line while the first thin-film transistor is turned on; and
current flows through the emissive display element and the corresponding one of the column power lines while the second thin-film transistor is turned on.

5. The drive system of claim 4, wherein the current measurement device measures the combined current from the emissive display elements while the second thin-film transistor is biased to operate in saturation.

6. The drive system of claim 4, wherein the current measurement device measures the combined current from the emissive display elements while the second thin-film transistor is biased for linear operation.

7. The drive system of claim 1, wherein the emissive display element is an OLED (organic light-emitting diode) and the emissive display device is an OLED display device.

8. The drive system of claim 1, wherein the first switches are of one type selected from a group consisting of polysilicon MOSFET (Metal Oxide Semiconductor Field Effect Transistor), alphasilicon MOSFET, TFT (Thin Film Transistor), and single crystalline silicon MOSFET.

9. A drive system for driving an emissive display device, the active matrix drive system configured to measure sub-pixel current in the emissive display device, the drive system comprising:
an active matrix drive circuit configured to drive current through a plurality of emissive display elements arranged in a matrix of a plurality of rows and a plurality of columns, each of the emissive display elements corresponding to a subpixel of the emissive display device and configured to have its current flow through a corresponding one of a plurality of column power lines;
a plurality of first switches each coupled to a corresponding one or more of the column power lines, the corresponding one or more of the column power lines receiving supply voltage if the corresponding first switch is turned on, but the corresponding one or more of the column power lines not receiving the supply voltage if the corresponding first switch is turned off; and
a current measurement device coupled to the plurality of first switches, the current measurement device configured to measure combined current through the column power lines.

10. The drive system of claim 9, wherein at least some of the first switches is turned off while the current measurement device measures the combined current through the column power lines.

11. The drive system of claim 9, further comprising:
a second switch coupled between the current measurement device and the supply voltage, the second switch being turned on to couple the current measurement device to the supply voltage or turned off to disconnect the current measurement device from the supply; and
a third switch coupled between the first switches and the supply voltage, the third switch being turned on to provide the supply voltage to the column power lines while the second switch is turned off, and the third switch being turned off while the second switch is turned on.

12. The drive system of claim 9, wherein the active matrix drive circuit includes, for each sub-pixel, a first n-channel thin film transistor, a second n-channel thin-film transistor, and a storage capacitor, and wherein:
a drain of the first thin-film transistor is coupled to a data line, a gate of the first thin-film transistor is coupled to a row line, and a source of the first thin-film transistor is coupled to a first side of the storage capacitor;
a second side of the storage capacitor is coupled to a drain of the second thin-film transistor and to a corresponding one of the column power lines;
a gate of the second thin-film transistor is coupled to the source of the first thin-film transistor and to the first side of the storage capacitor, a drain of the second thin-film transistor is coupled to the second side of the storage capacitor and to the corresponding one of the column power lines, and a source of the second thin-film transistor is coupled to an anode of the emissive display element of the sub-pixel;
the storage capacitor is charged according to data on the data line while the first thin-film transistor is turned on; and
current flows through the emissive display element and the corresponding one of the column power lines while the second thin-film transistor is turned on.

13. The drive system of claim 12, wherein the current measurement device measures the combined current through the column power lines while the second thin-film transistor is biased to operate in saturation.

14. The drive system of claim 12, wherein the current measurement device measures the combined current through the column power lines while the second thin-film transistor is biased to operate in linear operation.

15. The drive system of claim 9, wherein the emissive display element is an OLED (organic light-emitting diode) and the emissive display device is an OLED display device.

16. The drive system of claim 9, wherein the first switches are of one type selected from a group consisting of polysilicon MOSFET (Metal Oxide Semiconductor Field Effect Transistor), alphasilicon MOSFET, TFT (Thin Film Transistor), and single crystalline silicon MOSFET.

17. A method of measuring actual sub-pixel current of an emissive display device, the emissive display device including a plurality of sub-pixels, each sub-pixel including an emissive display element configured to flow current, the method comprising:
turning off the sub-pixels of the emissive display device;
turning on at least a column power line of the emissive display device while turning off remaining column power lines of the emissive display device;
measuring a background current I₁ of the emissive display device;
turning on a sub-pixel of the emissive display device;
measuring current I₂ through an emissive display element of the turned-on sub-pixel; and
determining a difference between the measured current I₂ and the background current I₁ to determine the actual sub-pixel current.

18. The method of claim 17, wherein the emissive display element is an OLED (organic light-emitting diode) and the emissive display device is an OLED display device.

19. An emissive display device comprising:
a plurality of emissive display elements arranged in a matrix of a plurality of rows and a plurality of columns, each of the emissive display elements corresponding to a subpixel of the emissive display device and configured to have its current flow through a corresponding one of a plurality of column power lines;
an active matrix drive circuit configured to drive current through the emissive display elements;
a plurality of first switches each coupled to a corresponding one or more of the column power lines, the corresponding one or more of the column power lines receiving supply voltage if the corresponding first switch is turned on, but the corresponding one or more of the column power lines not receiving supply voltage if the corresponding first switch is turned off; and
a current measurement device coupled to a common cathode of the emissive display elements, the current measurement device configured to measure combined current from emissive display elements.

20. The emissive display device of claim 19, wherein at least some of the first switches are turned off while the current measurement device measures the combined current from emissive display elements.

21. The emissive display device of claim 19, further comprising:
a second switch coupled between the current measurement device and the common cathode, the second switch being turned on to couple the current measurement device to the common cathode or turned off to disconnect the current measurement device from the common cathode; and
a third switch coupled between the common cathode and another supply voltage, the third switch being turned on while the second switch is turned off, and the third switch being turned off while the second switch is turned on.

22. An emissive display device comprising:
a plurality of emissive display elements arranged in a matrix of a plurality of rows and a plurality of columns, each of the emissive display elements corresponding to a subpixel of the emissive display device and configured to have its current flow through a corresponding one of a plurality of column power lines;
an active matrix drive circuit configured to drive current through the emissive display elements;
a plurality of first switches each coupled to a corresponding one or more of the column power lines, the corresponding one or more of the column power lines receiving supply voltage if the corresponding first switch is turned on, but the corresponding one or more of the column power lines not receiving supply voltage if the corresponding first switch is turned off; and
a current measurement device coupled to the plurality of first switches, the current measurement device configured to measure combined current through the column power lines.

23. The emissive display device of claim 22, wherein at least some of the first switches are turned off while the current measurement device measures the combined current through the column power lines.

24. The emissive display device of claim 22, further comprising:
a second switch coupled between the current measurement device and the supply voltage, the second switch being turned on to couple the current measurement device to the supply voltage or turned off to disconnect the current measurement device from the supply voltage; and
a third switch coupled between the first switches and the supply voltage, the third switch being turned on to provide the supply voltage to the column power lines while the second switch is turned off, and the third switch being turned off while the second switch is turned on.
